(19) United States
(12) Patent Application Publication
(10) Pub. No.: US 2016/0052412 A1
(43) Pub. Date: Feb. 25, 2016

(54) METHOD FOR CONTROLLING A POWER CONVERTER AND RELATED DEVICE

(71) Applicant: RENAULT S.A.S., Boulogne Billancourt (FR)

(72) Inventors: Noelle JANIAUD, Massy (FR); Pedro KVIESKA, Versailles (FR); Olivier REYSS, Montrouge (FR)

(73) Assignee: RENAULT s.a.s., Boulogne Billancourt (FR)

(21) Appl. No.: 14/784,132

(22) PCT Filed: Jun. 12, 2014
(86) PCT No.: PCT/FR2014/051439

§ 371 Date: Oct. 13, 2015

(30) Foreign Application Priority Data
Jun. 18, 2013 (FR) 1355714

(51) Int. Cl. B60L 11/18; H02M 1/00

(52) U.S. Cl. CPC B60L 11/1811; H02M 1/00; H02M 2001/0009

(57) ABSTRACT

A system for controlling a power converter, the system configured to control at least two consecutive instances of closure of pairs of controlled switches including a bottom switch and a top switch. A measurement mechanism can measure, prior to a transition between closing of one pair of controlled switches and closing of another pair of controlled switches, electric potential at a connection point for at least two arms in which the controlled switches are affected by the transition. A comparison mechanism compares the measured potentials and a selection mechanism can select the top switch of the arm with a lowest measured electric potential and the bottom switch of the arm with a highest measured electric potential. A controller can control closing of the controlled switches selected during at least one additional time period around the transition.

The invention relates to the control of a high-power charger, and more particularly to the control of a power converter of a battery charger of a motor vehicle with an at least partially electric drive.

A power converter can be an inverter or a rectifier. Voltage inverters are intended to provide an alternating voltage from a direct voltage, while the controlled rectifiers are intended to provide a direct voltage from an alternating voltage.

An inverter can be used for the variable speed control of a synchronous or asynchronous machine. In this case, it is necessary to provide charging, and more particularly each phase of the synchronous or asynchronous machine, or motor, with a voltage three-phase system which is as close as possible to a frequency and amplitude variable balanced sinusoidal three-phase system.

Voltage inverters are devices using power components carrying out controlled switching operations, like thyristors. The simplest inverters have two levels and consist of two controlled switches which alternately feed charging. Normally, a square wave signal is used as a setpoint to allow the switching of one or the other of the switches at each square wave side.

During the control of a power converter, such as a power converter of a battery charger of a motor vehicle with an at least partially electric drive, generally recovery times are inserted between each switching sequence. These recovery times are necessary to provide a current flow at any time and to prevent, at any moment, even an extremely short moment, all of the circuit breakers from being open and the current no longer being able to flow.

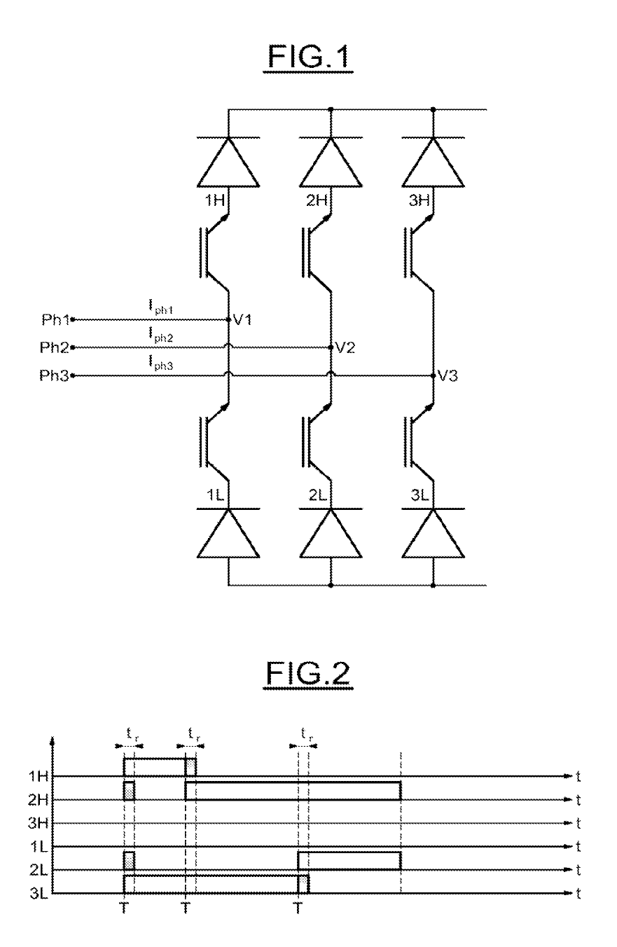

FIG. 1 illustrates a known current converter, of the current rectifier type, including three branches, or arms, each fed by a phase of a three-phase supply network, each branch including a series assembly successively including a first diode, a bottom circuit breaker 1L, 2L or 3L, a top circuit breaker 1H, 2H or 3H, and a second diode D. The diodes are assembled in the same conducting direction and connection to the phase is carried out between the two circuit breakers of a branch.

In a case as shown in FIG. 1, the current rectifier is without continuous freewheeling. Such a power converter is conventionally controlled via a succession of closures of a pair of a top circuit breaker 1H, 2H or 3H and of a bottom circuit breaker 1L, 2L or 3L, the other circuit breakers being open.

For example, the succession of closures can consist of a sequence including a succession of closures of the pairs (1H-3L)/(2H-3L)/(2H-2L).

The choice of the successive combinations is determined according to the current setpoints desired at the input of the converter Iₚₕ₁, Iₚₕ₂ and Iₚₕ₃, i.e. on the three-phase side.

When the closed top circuit breaker and bottom circuit breaker belong to the same arm, no power is then transferred between the alternating side and the direct side. This is then referred to as a freewheeling phase.

Since the time of opening and closing the circuit breakers is not instantaneous, it is necessary to insert a recovery between each circuit breaker pair closure in order to provide a passage for the current at any moment. The diodes of the circuit allow any risk of short-circuit of the three-phase alternating network to be prevented if two top or bottom circuit breakers are closed at the same moment.

FIG. 2 shows a timing diagram of the closed and open states of the circuit breakers of the converter of FIG. 1. The recovery times can be seen in FIG. 2.

The sequence of previous closures (1H-3L)/(2H-3L)/(2H-2L) is shown on the timing diagram of FIG. 2, the freewheeling phase corresponding to the last combination of the sequence involving the closure of the top and bottom circuit breakers of the second branch 2H and 2L.

The recovery times tr are shown by the hatched areas. Choosing the duration thereof depends on the closure and opening times for the chosen controlled circuit breakers. The recovery time tr must be as small as possible while being sufficient such that the opening of a top circuit breaker does not start before the closure of the following top circuit breaker. The same applies to the bottom circuit breakers.

The recovery time tr is generally inserted following the closure of a circuit breaker while extending the closure by the recovery time tr.

In FIG. 2, the top and bottom circuit breakers 2H and 2L of the second branch have a recovery time tr at the sequence start in order to provide continuity in the case where this sequence would, for example, be looped such as to repeat the same sequence of closures of pairs of circuit breakers.

By contrast, in a case where the sequence shown in FIG. 2, i.e. including a succession of closures of the pairs (1H-3L)/(2H-3L)/(2H-2L), was preceded by a different sequence ended by a freewheeling phase on the arm 1, namely a closure of the pair of circuit breakers (1H-1L), the recovery time tr would be inserted at the start of the sequence shown in FIG. 2 on the bottom circuit breaker 1L of the first arm. Since the top circuit breaker 1H of the first arm is involved in the closure of the pair (1H-3L), it remains in the closed state.

In the case of an electrical assembly as illustrated in FIG. 1 with a closure sequence as shown in FIG. 2, depending on the values of the electric potentials V₁, V₂ and V₃ of the connection points for the electric phases on the arms of the power converter, the recovery time is said to be “active” or “inactive”.

In the sequence illustrated in FIG. 2, (1H-3L)/(2H-3L)/(2H-2L), the first transition comprises the bottom circuit breaker 3L of the third arm being held in the closed state, and the top circuit breaker 1H of the first arm being opened and the top circuit breaker 2H of the second arm being closed.

During a transition between the two top circuit breakers 1H and 2H, the current can, at a given moment, only flow through a circuit breaker as a result of the diodes in series in the arm of the converter. Consequently, the current path is chosen following the blocking of a diode.

For the recovery phase during the recovery time tr, the moment when the current changes arm therefore depends on the voltage levels V₁ and V₂ of the first two phases Ph1 and Ph2. The top circuit breaker with the largest electric potential is the conducting circuit breaker.

In the case of a transition using two bottom circuit breakers, with the top circuit breaker remaining closed during the transition, the conducting bottom circuit breaker from the closed circuit breakers is the one with the lowest electric potential.

Therefore, in the example illustrated in FIGS. 1 and 2, if the electric potential V₂ of the second branch is greater than the electric potential V₁ of the first branch, V₂>V₁, the top circuit breaker 2H of the second branch is the conducting circuit breaker during the recovery time tr. The recovery time tr is then said to be “inactive” since the current flows in the top circuit breaker 2H of the second arm and no longer flows in the top circuit breaker 1H of the first arm as soon as the top circuit breaker 2H of the second arm is closed. The initially desired closure times are not modified, and no error is produced in the control process.

By contrast, if the electric potential V₂ of the second branch is less than the electric potential V₁ of the first branch, V₂<V₁, the top circuit breaker 1H of the first branch is the conducting circuit breaker during the recovery time tr. The recovery time tr is then said to be “active” since the current flows in the top circuit breaker 2H of the second arm than at the end of the recovery time tr, once the top circuit breaker 1H of the first arm is open. The initially desired closure times are therefore modified in this case, and an error is made in controlling the power converter.

As a result, the insertion of the recovery times tr can modify the initial setpoints due to the definition of a current path that is different to the path desired by the setpoint. These modifications of setpoints can then produce a cumulative error in the regulation. As a result, the performance of the overall system can be affected.

It is known to minimize the effect of the recovery times by means of material solutions which create additional costs and possible wear of materials, or by modifying the current or voltage high-level setpoints.

The aim of the invention is to minimize the number of active recovery times observed between two switching operations of circuit breakers while providing the primary security function of the recovery times, namely a possible flow of the current at any moment.

Another aim of the invention is for it to be applicable to power converters provided with two, three, four or more arms, and for it to be applicable to any type of converter without continuous freewheeling and having a diode in series with each circuit breaker, regardless of the technical field.

According to an aspect of the invention, a method for controlling a power converter is proposed in one implementation method. The power converter includes at least two arms connected in parallel, each arm comprising a series assembly of a unidirectional top switch and of a unidirectional bottom switch which are connected on either side of a connection point which is suitable for being connected to a phase of a power supply network. Each unidirectional switch includes a series assembly of a controlled circuit breaker and of a diode, the two diodes of a same arm being assembled in the same conducting direction. The method for controlling this power converter includes at least two successive closures of pairs of controlled circuit breakers, one pair of controlled circuit breakers being formed from a bottom circuit breaker and from a top circuit breaker.

According to a general feature of the invention, prior to a transition between the closure of a pair of controlled circuit breakers and the closure of another pair of controlled circuit breakers, the electric potential is measured at the connection point for at least the two arms, the controlled circuit breakers of which are involved in said transition. Then, the measured potentials are compared, and the closure of the top switch of the arm with the smallest measured electric potential and of the bottom switch of the arm with the largest measured electric potential is controlled for at least an additional period of time about the transition.

By maintained closures or by bringing forward the closures for recovery time of the top switch of the arm with the smallest measured electric potential and of the bottom switch of the arm with the largest measured electric potential, the risk of a recovery being an “active” recovery is reduced.

To this end, the recovery time is positioned by taking into account the moment of the transition and the switches used during the transition.

Therefore, with such a method, the closure of a switch can be prolonged after the switching transition moment for a time corresponding to the recovery period in a case where the top circuit breaker of the pair of switches closed before the transition belongs to the same arm with the lowest electric potential or in a case where the bottom circuit breaker of the pair of switches closed before the transition belongs to the arm with the highest electric potential.

By contrast, the closure of a switch can be lengthened in advance with respect to the switching transition moment for a time corresponding to the recovery period in a case where the top circuit breaker of the pair of switches closed after the transition belongs to the arm with the lowest electric potential or in a case where the bottom circuit breaker of the pair of switches closed after the transition belongs to the arm with the highest electric potential.

The robustness of the power converter regulation is, therefore, improved by maximizing the so-called “inactive” recovery times and minimizing, or even by removing, the so-called “active” recovery times.

In the case of a current rectifier controlled according to the method defined above, the AC-side current setpoints are produced without introducing an error due to the active recovery time.

Moreover, the closure control of the method defined above allows the harmonics of the network to be reduced as a result of the improvement in regulation.

Preferably, the method includes a plurality of sequences of at least two successive closures of pairs of controlled circuit breakers, each sequence including a freewheeling phase corresponding to the closure of the two circuit breakers of a same arm.

The risk that the recovery times are so-called “active” recoveries is greater during a transition between two sequences than during a transition in the course of a sequence since the order of the electric potentials and the pairs of controlled switches of the following sequence start are not known. They are predicted using the measurements and the states at the start of the preceding sequence. By measuring, after determining the succession of closures of pairs of switches of a sequence and before the start of the sequence, the electric potentials of the arms, at least one of the circuit breakers of which belongs to the first pair of top and bottom circuit breakers which has to be closed at the start of this sequence, it is therefore possible to determine the circuit breakers which must be kept closed for a recovery time after the transition or closed in advance before the transition for a recovery time.

Advantageously, the electric potential is measured at the connection point of each arm before each sequence, and the closure is maintained for the entire sequence.

Thus, at the sequence start, the top switch of the arm with the smallest electric potential and the bottom switch of the arm with the largest electric potential are closed for the entire sequence, irrespective of the switching operations resulting from the power flow and freewheeling phases. A single measurement of the potentials before the sequence is sufficient to determine which switches will be closed for the entire sequence.

By systematically closing the top switch of the arm with the smallest electric potential and the bottom switch of the arm with the largest electric potential from the circuit breakers of all of the arms of the converter, it is therefore possible to introduce recovery time on the other switches controlled during a sequence. Therefore, the method does not involve any determination for placement of recovery time about each of the transitions.

Thus, the number of so-called “active” recovery times is reduced.

Advantageously, said closure can be maintained for the entire sequence with the exception of the freewheeling phase, the closure being interrupted at the end of a recovery period following the start of the freewheeling phase and the closure being resumed at a moment corresponding to a recovery period prior to the end of the freewheeling phase.

In the case where the sequence is ended by the freewheeling phase, the closure can therefore be maintained from the start of the sequence up to at least a moment corresponding to a recovery period following the start of the freewheeling phase and not up to the end of the sequence.

Therefore, at the sequence start, the top switch of the arm with the smallest measured electric potential and the bottom switch of the arm with the largest measured electric potential are closed until the freewheeling phase has started from a time identical to a recovery time. This closure is carried out independently of the switching operations carried out during the transitions between two power phases within the sequence. A power phase is a different phase to the freewheeling phase.

When the switches of a pair in question are kept closed over the entire sequence, it is possible to have so-called “active” recovery times if the order of the potentials changes during the sequence with respect to the measurement carried out before the sequence. This risk is all the more great during a freewheeling phase at the sequence end.

Since the measurement is carried out before or at the start of the sequence, a change of order of the electric potentials at the connection points will only be taken into account during the following sequence. It is then possible that the two switches closed for the entire sequence in order to prevent the occurrence of “active” recovery times become switches giving rise to “active” recovery times if they are closed, particularly on the freewheeling phase.

In such a case, the freewheeling phase can become a power transfer phase since the closed switches through which the current flows do not belong to the same arm, and do not, therefore, have the same electric potential. This change between the freewheeling phase and a power transition phase can cause large damage to the components.

By keeping closed the top switch of the arm with the smallest measured electric potential and the bottom switch of the arm with the largest measured electric potential only up to the freewheeling phase and more particularly up to a moment corresponding to a recovery time following the start of the freewheeling phase, the risks of damage to the components are very greatly reduced since the freewheeling phase is only reduced by a short time identical to the recovery period.

Thus, the number of so-called “active” recovery times is further reduced than when the closure of the switches in question is maintained for the entire sequence.

A controlled switch concerned both by said closure of the top or bottom switch, the electric potential of the arm of which is the smallest or largest, respectively, and by the freewheeling phase will remain closed throughout the entire sequence.

Advantageously, it is possible to start the sequence with a freewheeling phase carried out with the same pair of controlled circuit breakers as the freewheeling phase on which the previous sequence ended.

Starting a sequence of closures with a freewheeling phase identical to the freewheeling phase having ended the previous sequence allows any risk of so-called “active” recovery to be prevented at the sequence start, since it does not require any introduction of recovery time at the moment of the transition between two sequences.

Thus, it is possible to carry out a first measurement of the electric potentials at the sequence start, during the sequence start freewheeling phase. Since the sequence has already commenced, the succession of closures is fully known, and the control means have the time to choose the circuit breakers to be closed when necessary in order to prevent the so-called “active” recovery times.

According to another aspect of the invention, a system for controlling a power converter including at least two arms connected in parallel is proposed in one embodiment, each arm comprising a series assembly of a unidirectional top switch and of a unidirectional bottom switch which are connected on either side of a connection point which is suitable for being connected to a phase of a power supply network. Each unidirectional switch includes a series assembly of a controlled circuit breaker and of a diode, the two diodes of a same arm being assembled in the same conducting direction. The system is suitable for controlling at least two successive closures of pairs of controlled circuit breakers formed from a bottom circuit breaker and from a top circuit breaker.

According to a general feature of the invention, the system includes measuring means for measuring, prior to a transition between the closure of a pair of controlled circuit breakers and the closure of another pair of controlled circuit breakers, the electric potential at the connection point for at least the two arms, the controlled circuit breakers of which are involved in said transition, means for comparing the measured potentials, and selection means for selecting the top switch of the arm with the smallest measured electric potential and the bottom switch of the arm with the largest measured electric potential, and control means for controlling the closure of the selected controlled switches during at least one additional time period about the transition.

Preferably, the system includes a sequential module for defining a sequence of a least two successive closures of pairs of controlled circuit breakers, each sequence ending with a freewheeling phase corresponding to the closure of the two circuit breakers of a same arm.

The measuring means can, advantageously, be configured to measure the electric potential at the connection point of each arm, and the control means are configured to control a maintained closure from the start of the sequence up to at least a moment corresponding to a recovery period following the start of the freewheeling phase.

Advantageously, the sequential module can be configured to define a sequence starting with a freewheeling phase carried out with the same pair of controlled circuit breakers as the freewheeling phase on which the previous sequence ended.

The power converter can, advantageously, be included in a battery charger on board an electric motor vehicle.

Other advantages and features of the invention will emerge upon examining the detailed description of implementation methods and of an embodiment, which are in no way limiting, and the appended drawings, wherein:

FIG. 1, which has already been described, schematically shows a current converter according to the prior art;

FIG. 2, which has already been described, shows a timing diagram of a sequence for controlling pair closures for controlled circuit breakers of the power converter of FIG. 1 according to the prior art;

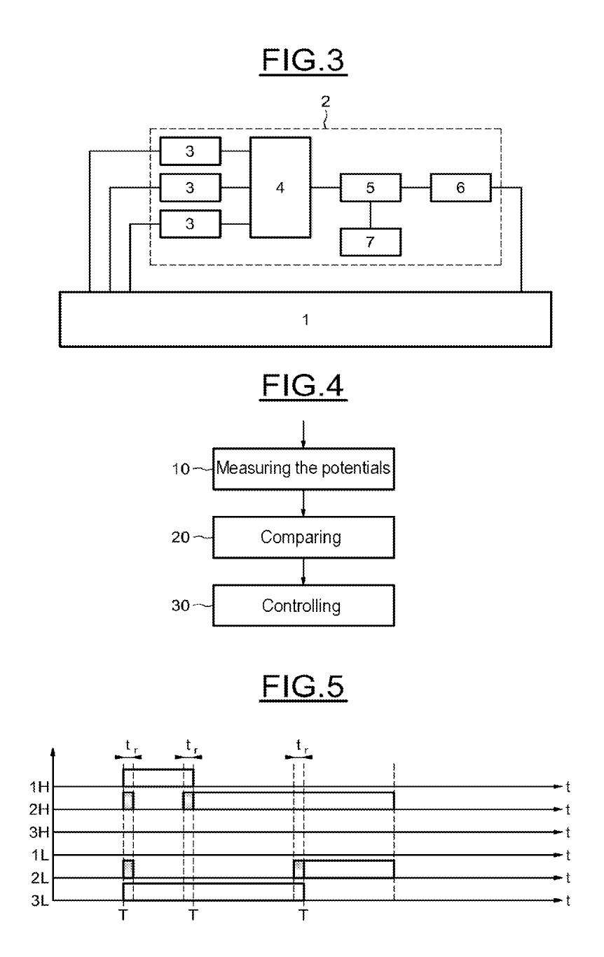

FIG. 3 schematically shows a system for controlling a power converter according to an embodiment of the invention;

FIG. 4 illustrates a block diagram of a method for controlling a power converter according to a method of implementing the invention;

FIG. 5 shows a timing diagram of a first sequence example for controlling closures of pairs of controlled circuit breakers of the power converter according to a first implementation method;

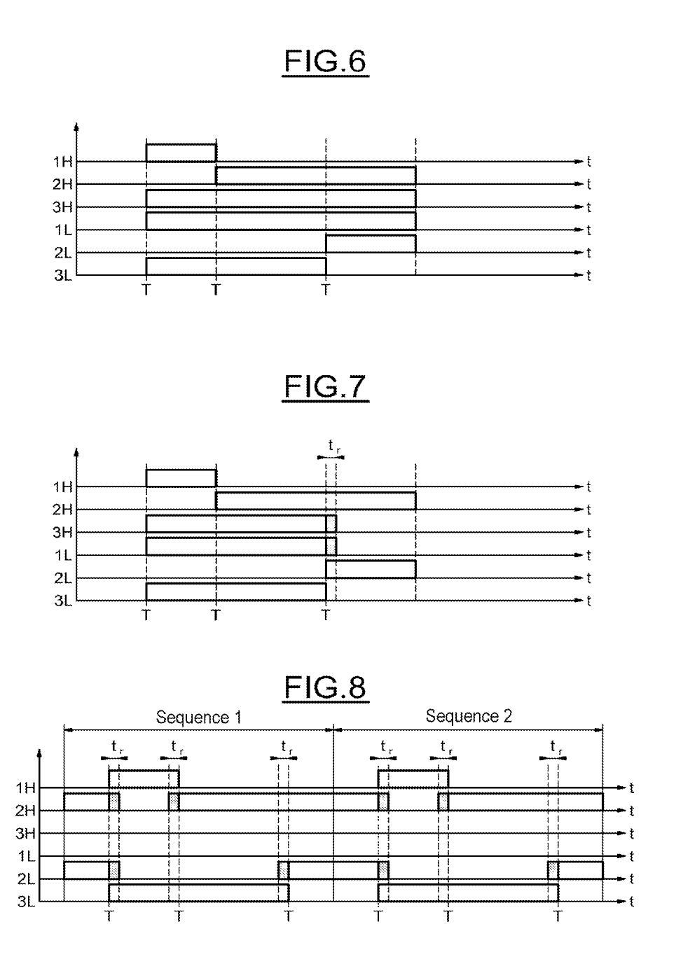

FIG. 6 shows a timing diagram of a second sequence example for controlling closures of pairs of controlled circuit breakers of the power converter according to a second implementation method;

FIG. 7 shows a timing diagram of a third sequence example for controlling closures of pairs of controlled circuit breakers of the power converter according to a third implementation method;

FIG. 8 shows a timing diagram of a fourth sequence example for controlling closures of pairs of controlled circuit breakers of the power converter according to a fourth implementation method.

FIG. 3 shows a system for controlling a power converter 1 according to an embodiment of the invention.

In the embodiment shown in FIG. 3, the control system 2 drives a control converter including three arms connected in parallel like the current converter illustrated in FIG. 1. Each unidirectional switch includes a series assembly of a controlled circuit breaker and of a diode, the two diodes of a same arm being assembled in the same conducting direction. The same references as those in FIG. 1 will be used particularly to refer to the controlled circuit breakers of the unidirectional switches and the electric potentials. Each arm comprises a series assembly of a unidirectional top switch and of a unidirectional bottom switch which are connected on either side of a connection point suitable for being connected to a phase of a power supply network.

The power converter 1 driven by the control system 2 shown in FIG. 3 is included in a battery charger on board an electric motor vehicle.

The control system 2 includes three voltage sensors 3 arranged such as to measure, on the power converter 1, the electric potential V₁, V₂ and V₃ at the connection point for the phases Ph1, Ph2, Ph3 of a power supply network on the arms.

The control system 2 further includes a comparator 4 for carrying out a comparison between two or three potentials V₁, V₂ and V₃ measured according to the number of measured potentials.

In another embodiment, a control system can be configured to control a power converter having more than three arms, in which case the comparator is configured to compare a number of potentials that is the same as the number of arms of the converter.

The control system 2 further includes selection means 5 and control means 6. The selection means 5 are configured such as to select the top switch 1H, 2H or 3H of the arm with the smallest measured electric potential V₁, V₂ and V₃ and the bottom switch 1B, 2B or 3B of the arm with the largest measured electric potential V₁, V₂ and V₃. The control means 6 are configured such as to control the closure of the selected controlled switches for at least one additional time period tr about the transition according to the method of implementing the chosen control method.

Various implementation methods are explained hereafter.

The control system 2 further includes a sequential module 7 defining sequences of at least two successive closures of pairs of controlled circuit breakers. The sequential module 7 is connected at an input of the selection means 5. Therefore, the selection means can, furthermore, take into account the closures of the sequence underway or to take place in order to determine the controlled circuit breakers to be closed in order to minimize, or prevent, the so-called “active” recovery times.

FIG. 4 shows a block diagram of a method for controlling a power converter 1 according to a method of implementing the invention. The control method is implemented by the control system 2 illustrated in FIG. 3.

In an initial step 10, the electric potential V₁, V₂ and V₃ is measured at the connection point for at least two arms of the three arms of the power converter 1, the measurements being carried out at least for the two arms, the controlled circuit breakers of which are closed before or after a closure transition.

A closure transition corresponds to the moment between the closure of a pair of controlled circuit breakers and the closure of another pair of controlled circuit breakers. More precisely, a transition corresponds to the moment where at least one circuit breaker of a pair closes and at least one circuit breaker of another pair opens.

Then, in a step 20, the measured potentials are compared, and then, in a step 30, the closure of the top switch of the arm with the smallest measured electric potential and of the bottom switch of the arm with the largest measured electric potential is controlled for at least one additional time period about the transition according to the chosen implementation method.

FIG. 5 shows a timing diagram of a first sequence example for controlling closures of pairs of controlled circuit breakers of the power converter 1 according to a first implementation method.

In this implementation method, prior to each closure transition, in the course of the sequence or between two sequences, the electric potentials are measured at the connection point of the two arms, the controlled circuit breakers of which are closed before or after the transition.

According to the result of the comparison of the two potentials, closures are maintained or the closures are brought forward for a recovery time tr for the top switch of the arm with the smallest measured electric potential and for the bottom switch of the arm with the largest measured electric potential. Therefore, the risk that a recovery is an “active” recovery is reduced.

In the timing diagram of FIG. 5, the electric potentials of the arms are ordered such that V₁>V₂>V₃. Using these values of potentials and the pairs of controlled circuit breakers closed before and after each transition, the closures of the sequence shown on the timing diagram including the succession of closures of pairs of circuit breakers (1H-3L)/(2H-3L)/(2H-2L) have been brought forward or prolonged by a recovery time tr.

In the timing diagram of FIG. 5, during the closure transition from the pair (1H-3L) to the pair (2H-3L), the top transistor 1H of the first arm is open and the top transistor 2H of the second arm is closed whereas the bottom transistor 3L of the third arm remains closed. Since the potential V₂ of the second arm is less than the potential V₁ of the first arm, the top circuit breaker 2H of the second arm is closed for a recovery time tr after the transition such as to maintain a current path at any moment while preventing the occurrence of a so-called “active” recovery.

During the following closure transition from the pair (2H-3L) to the pair (2H-2L), the bottom transistor 3L of the third arm is open and the bottom transistor 2L of the second arm is closed whereas the top transistor 2H of the second arm remains closed. Since the potential V₃ of the third arm is less than the potential V₂ of the second arm, the bottom circuit breaker 2L of the second arm is closed for a recovery time tr prior to the transition and is kept closed from the transition such as to maintain a current path at any moment while preventing the occurrence of a so-called “active” recovery.

At the sequence start, while the controlled circuit breakers of the pair (1H-3L) are closed, the timing diagram shows a closure of the top and bottom circuit breakers 2H and 2L of the second arm for a recovery time tr. This closure is carried out in the case where the sequence shown on the timing diagram of FIG. 5 is subsequently repeated. By therefore keeping the top and bottom circuit breakers 2H and 2L of the second arm closed while the top circuit breaker 1H of the first arm and the bottom circuit breaker 3L of the third arm are closed, this ensures that a current path is maintained at any moment and that there is no “active” recovery.

The implementation method shown on the timing diagram of FIG. 5 involves a measurement prior to each closure transition of the electric potentials of the arms involved in the transition, whether the closure transition is carried out in the course of a sequence or during a sequence change.

The risk that the recovery times are so-called “active” recoveries is greater during a transition between two sequences than during a transition in the course of a sequence since the order of the electric potentials and the pairs of controlled switches of the following sequence start are not known. They are predicted from the measurements and from the states at the start of the previous sequence. During a transition occurring between two sequences, after determining the succession of closures of pairs of switches of a sequence and prior to the start of the following sequence, measurement is therefore carried out of the electric potentials of the arms, at least one of the circuit breakers of which belongs to the first pair of top and bottom circuit breakers that must be closed at the start of the sequence. It is, therefore, possible to determine the circuit breakers that must be kept closed for a recovery time after the transition or closed in advance prior to the transition for a recovery time.

FIG. 6 shows a timing diagram of a second sequence example for controlling closures of pairs of controlled circuit breakers of the power converter 1 according to a second implementation method.

In this implementation method, the electric potentials are measured at the connection point of all of the arms, i.e. the three in this case. The measurement takes place only before each sequence start.

The three measured potentials are then compared and the arm with the highest potential and the arm with the smallest potential are determined. V₁>V₂>V₃ applies in the illustrated case.

In this second implementation method, the top circuit breaker, the arm of which has the smallest electric potential, 3H in the example illustrated in FIG. 6, and the bottom circuit breaker, the arm of which has the highest potential, 1L in this example, are closed throughout the entire sequence.

The closure of the circuit breakers 3H and 1L therefore allows recovery time to be introduced on the other switches controlled during the sequence. Thus, the method does not involve any determination of placement of recovery time about each of the transitions, while minimizing the number of so-called “active” recovery times.

FIG. 7 shows a timing diagram of a third sequence example for controlling closures of pairs of controlled circuit breakers of the power converter 1 according to a third implementation method.

In this implementation method, the electric potentials are also measured at the connection point of all of the arms, i.e. the three in this case. As in the previous implementation method illustrated in FIG. 6, the measurement is carried out only before each sequence start. V₁>V₂>V₃ also applies in the illustrated case.

The method differs from the previous implementation method illustrated in FIG. 6 in that the closure of the circuit breakers 3H and 1L is not maintained throughout the entire sequence but only up to the freewheeling phase and, more particularly, up to a moment corresponding to a recovery period following the start of the freewheeling phase wherein the controlled circuit breakers 2H and 2L of the second arm are closed.

This third implementation method therefore allows the number of so-called “active” recoveries to be reduced all the more in relation to the second implementation method.

FIG. 8 shows a timing diagram of a fourth sequence example for controlling closures of pairs of controlled circuit breakers of the power converter 1 according to a fourth implementation method.

In this implementation method, the electric potentials are measured regularly prior to the transitions in the course of a sequence and prior to a sequence. Only the electric potentials of the two arms, the controlled circuit breakers of which are closed prior to or after the transition, are measured.

In the fourth implementation method illustrated in FIG. 8, each sequence starts with a freewheeling phase carried out with the same pair of controlled circuit breakers as the freewheeling phase on which the previous sequence ended.

As already stated above, the risk that the recovery times are so-called “active” recoveries is greater during a transition between two sequences than during a transition in the course of a sequence since the order of the electric potentials and the pairs of controlled switches of the following sequence start are not known. Starting a sequence of closures with a freewheeling phase identical to the freewheeling phase which has ended the previous sequence allows any risk of so-called “active” recovery at the sequence start to be prevented, since it does not require any introduction of recovery time at the moment of the transition between two sequences.

Thus, it is possible to carry out a first measurement of the electric potentials at the sequence start, during the sequence start freewheeling phase. Since the sequence has already commenced, the succession of closures is fully known, and the control means have the time to choose the circuit breakers to be closed when necessary in order to prevent the so-called “active” recovery times.

In the timing diagram of FIG. 8, the electric potentials of the arms have values such that V₁>V₂>V₃. In the illustrated example, the sequences 1 and 2 include a succession of closures of pairs of circuit breakers (2H-2L)/(1H-3L)/(2H-3L)/(2H-2L), with the freewheeling phases (2H-2L) being reduced by half with respect to the sequence of FIG. 5 such that the total freewheeling phase of the sequence 1 or of the sequence 2 of FIG. 8 is temporarily identical to that of the sequence of FIG. 5.

In the timing diagram of FIG. 8, at the start of sequence 1, the top and bottom circuit breakers 2H and 2L of the second arm are closed. During the transition with the closure of the controlled circuit breakers of the pair (1H-3L), given the potentials of the arms, the top and bottom circuit breakers 2H and 2L of the second arm are kept closed during a recovery time tr such as to ensure that a current path is maintained at any moment and such that there is a so-called “inactive” recovery.

During the following closure transition from the pair (1H-3L) to the pair (2H-3L), the top transistor 1H of the first arm is open and the top transistor 2H of the second arm is closed whereas the bottom transistor 3L of the third arm remains closed. Since the potential V₂ of the second arm is less than the potential V₁ of the first arm, the top circuit breaker 2H of the second arm is closed for a recovery time tr prior to the transition such as to maintain a current path at any moment while preventing the occurrence of a so-called “active” recovery.

During the following closure transition from the pair (2H-3L) to the pair (2H-2L), the bottom transistor 3L of the third arm is open and the bottom transistor 2L of the second arm is closed whereas the top transistor 2H of the second arm remains closed. Since the potential V₃ of the third arm is less than the potential V₂ of the second arm, the bottom circuit breaker 2L of the second arm is closed for a recovery time tr prior to the transition and is kept closed from the transition such as to maintain a current path at any moment while preventing the occurrence of a so-called “active” recovery.

The following sequence 2 is a copy of sequence 1.

The invention, therefore, allows for the simple minimization of the number of so-called “active” recovery times observed between two switching operations for circuit breakers while providing the primary safety function of the recovery times, namely a possible flow of the current at any moment. The invention can be used for power converters provided with two, three, four or more arms, and can be used for any type of converter without continuous freewheeling and having a diode in series with each circuit breaker, regardless of the technical field.

1-8. (canceled)

9: A method for controlling a power converter including at least two arms connected in parallel, each arm including a series assembly of a unidirectional top switch and a unidirectional bottom switch that are connected on either side of a connection point that can be connected to a phase of a power supply network, each unidirectional switch including a series assembly of a controlled circuit breaker and a diode, the two diodes of a same arm being assembled in a same conducting direction,
the method comprising:
a plurality of sequences each comprising at least closure of a top circuit breaker and a bottom circuit breaker of two separate arms, each sequence further comprising at least one freewheeling phase corresponding to closure of the two circuit breakers of a same arm;
prior to each sequence start, measuring connection potentials of each arm,
comparing the measured potentials, and determining the arm with a largest potential and the arm with a smallest potential,
controlling closure of the top switch of the arm with the smallest measured electric potential and the bottom switch of the arm with the largest measured electric potential, the closure being maintained for an entire sequence at least outside of the freewheeling phases.

10: The method as claimed in claim 9, wherein the closure is maintained for the entire sequence.

11: The method as claimed in claim 9, wherein the closure is maintained for the entire sequence with exception of the freewheeling phases, the closure being interrupted at an end of a recovery period following start of a freewheeling phase and the closure taking place at a moment corresponding to a recovery period prior to the end of the freewheeling phase.

12: The method as claimed in claim 9, wherein the sequence is started with a freewheeling phase carried out with the same pair of controlled circuit breakers as the freewheeling phase on which the previous sequence ended.

13: A system for controlling a power converter including at least two arms connected in parallel, each arm including a series assembly of a unidirectional top switch and a unidirectional bottom switch that are connected on either side of a connection point that can be connected to a phase of a power supply network, each unidirectional switch including a series assembly of a controlled circuit breaker and a diode, the two diodes of a same arm being assembled in a same conducting direction,
the system configured to:
control a plurality of sequences each comprising at least closure of a top circuit breaker and a bottom circuit breaker of two separate arms, each sequence further comprising at least one freewheeling phase corresponding to the closure of the two circuit breakers of a same arm,
the system comprising:
measuring means for measuring, prior to each sequence start, electric potentials of the connection points of each arm;
means for comparing the measured potentials;
selection means for selecting the top switch of the arm with the smallest measured electric potential and the bottom switch of the arm with the largest measured electric potential; and
control means for controlling the closure of the selected controlled switches and for maintaining the closure for an entire sequence at least outside of the freewheeling phases.

14: The system as claimed in claim 13, wherein the control means is configured to control a maintained closure from a start of the sequence up to at least a moment corresponding to a recovery period following a start of the freewheeling phase.

15: The system as claimed in claim 13, wherein the sequential module is configured to define a sequence starting with a freewheeling phase carried out with the same pair of controlled circuit breakers as the freewheeling phase on which the previous sequence ended.

16: The system as claimed in claim 14, wherein the sequential module is configured to define a sequence starting with a freewheeling phase carried out with the same pair of controlled circuit breakers as the freewheeling phase on which the previous sequence ended.

17: The system as claimed in claim 13, wherein the power converter is included in a battery charger on board an electric motor vehicle.

18: The system as claimed in claim 14, wherein the power converter is included in a battery charger on board an electric motor vehicle.

19: The system as claimed in claim 15, wherein the power converter is included in a battery charger on board an electric motor vehicle.

20: The system as claimed in claim 16, wherein the power converter is included in a battery charger on board an electric motor vehicle.
